(19) United States
(12) Patent Application Publication
(10) Pub. No.: US 2006/0153026 A1
(43) Pub. Date: Jul. 13, 2006

(54) Device and method for recording information

(75) Inventors: Johannis Friso Rendert Blacquiere, Eindhoven (NL); Pope Ijtsma, Eindhoven (NL); Dirk Hamelinck, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 10/561,463

(22) PCT Filed: Jun. 17, 2004
(86) PCT No.: PCT/IB04/50931

§ 371 Date: Dec. 20, 2005

(30) Foreign Application Priority Data
Jun. 23, 2003 (EP) 03101838.5

(51) Int. Cl. G11B 5/09

(52) U.S. Cl. 369/47.1

(57) ABSTRACT

A device for recording records information in blocks having logical addresses in a storage space on a record carrier. The device has an interfacing unit (31) for communicating with a host system by exchanging commands and information, a record carrier status unit (32) for detecting a record carrier update status in which information stored on the record carrier is to be changed, and an update unit (33) for initiating an unmount-mount sequence. The unmount-mount sequence is initiated by the device and starts with an unmount process (42) for, via the interfacing means, forcing the host system to relieve control of the record carrier. Then the device has taken control and performs an update process (44) for said changing of information on the record carrier. Finally the control is returned to the host by a mount process (45) that forces the host system to accept the changed information.

The invention relates to a device for recording information in blocks having logical addresses in a storage space on a record carrier.

The invention further relates to a method of recording information.

The invention further relates to a computer program product for recording information.

The invention relates to the field of physically organizing recorded data in recording systems, and in particular to defect management when recording real-time information such as video.

A device and method for recording information on a record carrier are known from U.S. Pat. No. 6,205,529. Data recorded on a record carrier tends to be fragmented due to normal use and updates of stored data files. Defragmenting is used to reorganize the stored data such that files are stored in contiguous physical areas. The recording device is controlled via an interface by a host system. The host system determines the need for defragmentation of files using conventional defragmentation techniques. The device has a new copy command to perform a copy function internally in the device, i.e. without transferring the data back and forth to the host, thus freeing up the host system for performing other tasks until the device signals completion of the new copy command. A problem with the known device is that the host system needs to be aware of the new copy command, because the new command is not available in standard interfacing commands.

It is an object of the invention to provide a system for organizing data recorded on a record carrier which reduces the involvement of the host system.

For this purpose in accordance with a first aspect of the invention the device for recording comprises recording means for recording marks in a track on the record carrier representing the information, and control means for controlling the recording by locating each block at a physical address in the track, the control means comprising interfacing means for communicating with a host system by exchanging commands and information, record carrier status means for detecting a record carrier update status in which information stored on the record carrier is to be changed, and update means for initiating an unmount-mount sequence in dependence on the record carrier update status, the unmount-mount sequence comprising an unmount process for, via the interfacing means, forcing the host system to complete pending actions and write any information maintained by the host to the record carrier, an update process for said changing of information on the record carrier, and a mount process for, via the interfacing means, forcing the host system to accept the changed information by retrieving from the updated record carrier any information required by the host.

For this purpose in accordance with further aspects of the invention a method and computer program product for recording and/or reading are given in the claims.

The measures according to the invention have the effect that via the unmount-mount sequence the device acquires control over the record carrier, while temporarily relieving the host system. Advantageously the recording device initiates any reorganizing of recorded information by detecting the update status, which detecting may include information available only to the recording device, such as defect management information.

The invention is also based on the following recognition. The inventors have seen that a recording device can be equipped with sufficient knowledge to determine the need for re-organizing data on a record carrier. However, normally the host is in control, and recorded data may not be changed without the host being informed. Standard unmount and mount commands are usually available in interface commands for being activated by a user ejecting or inserting a record carrier. A virtual act of eject and insert can be initiated by the device for temporarily taking over the control over the record carrier, and changing any information on the record carrier.

In an embodiment of the device the update means are adapted for including in the update process changing the size of the storage space. This has the advantage that when the device detects that other areas on the record carrier, such as defect management areas, require more (of less) space, the amount of storage space can be adapted. Hence the practical use of the record carrier is extended.

In an embodiment of the device the control means comprise defect management means for detecting defects and maintaining the defect management information in defect management areas on the record carrier, and the update means are adapted for including in the update process changing the content, size and/or location of the defect management areas. This has the advantage that the defect management areas can be adapted to the actual number of defects occurring.

Further embodiments are given in the dependent claims.

These and other aspects of the invention will be apparent from and elucidated further with reference to the embodiments described by way of example in the following description and with reference to the accompanying drawings, in which

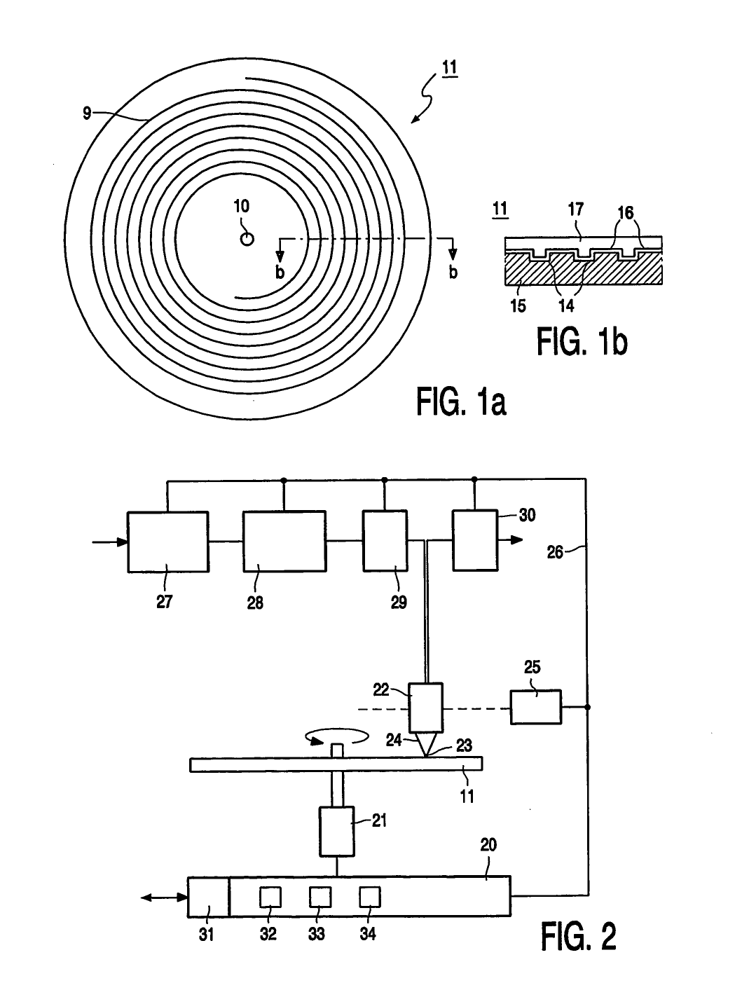

FIG. 1a shows a record carrier (top view),

FIG. 1b shows a record carrier (cross section),

FIG. 2 shows a recording device,

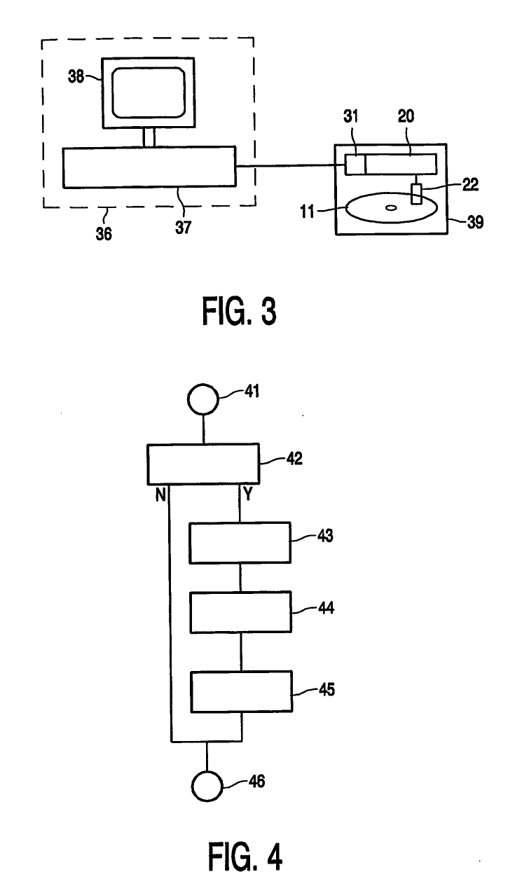

FIG. 3 shows a host system interfacing to a recording device, and

FIG. 4 shows a process for detecting an update status and performing an unmount-mount sequence.

Corresponding elements in different Figures have identical reference numerals.

FIG. 1a shows a disc-shaped record carrier 11 having a track 9 and a central hole 10. The track 9, being the position of the series of (to be) recorded marks representing information, is arranged in accordance with a spiral pattern of turns constituting substantially parallel tracks on an information layer. The record carrier may be optically readable, called an optical disc, and has an information layer of a recordable type. Examples of a recordable disc are the CD-R and CD-RW, and writable versions of DVD, such as DVD+RW, and the high density writable optical disc using blue lasers, called Blu-ray Disc (BD). Further details about the DVD disc can be found in reference: ECMA-267: 120 mm DVD—Read-Only Disc—(1997). The information is represented on the information layer by recording optically detectable marks along the track, e.g. crystalline or amorphous marks in phase change material. The track 9 on the recordable type of record carrier is indicated by a pre-embossed track structure provided during manufacture of the blank record carrier. The track structure is constituted, for example, by a pregroove 14 which enables a read/write head to follow the track during scanning. The track structure comprises position information including so-called physical addresses, for indicating the location of units of information, usually called information blocks. The position information includes specific synchronizing marks for locating the start of such information blocks.

FIG. 1b is a cross-section taken along the line b-b of the record carrier 11 of the recordable type, in which a transparent substrate 15 is provided with a recording layer 16 and a protective layer 17. The protective layer 17 may comprise a further substrate layer, for example as in DVD where the recording layer is at a 0.6 mm substrate and a further substrate of 0.6 mm is bonded to the back side thereof. The pregroove 14 may be implemented as an indentation or an elevation of the substrate 15 material, or as a material property deviating from its surroundings.

The record carrier 11 is intended for carrying digital information in blocks under control of a file management system, the information including realtime information to be recorded and reproduced continuously, in particular information representing digitally encoded video according to a standardized format like MPEG2.

FIG. 2 shows a recording device for writing information on a record carrier 11 of a type which is writable or re-writable, for example CD-R or CD-RW, or DVD+RW or BD. The device is provided with recording means for scanning the track on the record carrier which means include a drive unit 21 for rotating the record carrier 11, a head 22, a positioning unit 25 for coarsely positioning the head 22 in the radial direction on the track, and a control unit 20. The head 22 comprises an optical system of a known type for generating a radiation beam 24 guided through optical elements focused to a radiation spot 23 on a track of the information layer of the record carrier. The radiation beam 24 is generated by a radiation source, e.g. a laser diode. The head further comprises (not shown) a focusing actuator for moving the focus of the radiation beam 24 along the optical axis of said beam and a tracking actuator for fine positioning the spot 23 in a radial direction on the center of the track The tracking actuator may comprise coils for radially moving an optical element or may alternatively be arranged for changing the angle of a reflecting element. For writing information the radiation is controlled to create optically detectable marks in the recording layer. The marks may be in any optically readable form, e.g. in the form of areas with a reflection coefficient different from their surroundings, obtained when recording in materials such as dye, alloy or phase change material, or in the form of areas with a direction of magnetization different from their surroundings, obtained when recording in magneto-optical material. For reading the radiation reflected by the information layer is detected by a detector of a usual type, e.g. a four-quadrant diode, in the head 22 for generating a read signal and further detector signals including a tracking error and a focusing error signal for controlling said tracking and focusing actuators. The read signal is processed by read processing unit 30 of a usual type including a demodulator, deformatter and output unit to retrieve the information. Hence retrieving means for reading information include the drive unit 21, the head 22, the positioning unit 25 and the read processing unit 30. The device comprises write processing means for processing the input information to generate a write signal to drive the head 22, which means comprise an input unit 27, and modulator means comprising a formatter 28 and a modulator 29. During the writing operation, marks representing the information are formed on the record carrier. The marks are formed by means of the spot 23 generated on the recording layer via the beam 24 of electromagnetic radiation, usually from a laser diode. Writing and reading of information for recording on optical disks and formatting, error correcting and channel coding rules are well-known in the art, e.g. from the CD and DVD system.

The control unit 20 is connected via control lines 26, e.g. a system bus, to said input unit 27, formatter 28 and modulator 29, to the read processing unit 30, and to the drive unit 21, and the positioning unit 25. The control unit 20 comprises control circuitry, for example a microprocessor, a program memory and control gates, for performing the procedures and functions according to the invention as described below. The control unit 20 may also be implemented as a state machine in logic circuits. The control unit 20 controls the recording and retrieving of information and may be arranged for receiving commands from a user or from a host computer.

The input unit 27 receives blocks of information, for example audio and/or video, which are passed to the formatter 28 for adding control data and formatting the data as information blocks according to a predefined recording format, e.g. by adding error correction codes (ECC) and/or interleaving. The formatted data from the output of the formatter 28 is passed to the modulation unit 29, which comprises for example a channel coder, for generating a modulated signal which drives the head 22. Further the modulation unit 29 comprises synchronizing means for including synchronizing patterns in the modulated signal. The formatted units presented to the input of the modulation unit 29 comprise address information and are written to corresponding addressable locations on the record carrier under the control of control unit 20, and for performing defect management as described below.

In an embodiment of the device the input unit 27 is arranged for receiving real-time information. The input unit may comprise compression means for input signals such as analog audio and/or video, or digital uncompressed audio/video. Suitable compression means are described for audio in WO 98/16014-A1 (PHN 16452), and for video in the MPEG2 standard. The input signal may alternatively be already digitally encoded.

The control unit 20 is arranged for controlling the recording by locating each block at a physical address in the track, and includes the following cooperating functional units: an interfacing unit 31, a record carrier status detection unit 32, a update unit (33) and (optionally) a defect management unit 34. The control unit includes the following functions. First physical addresses are translated into logical addresses and vice versa according to a predefined record carrier format, for example in dependence of defect management information. The logical addresses constitute a contiguous storage space to be used for storing files of information blocks under control of a file management system, for example UDF.

The interfacing unit 31 is included for communicating with a host system for exchanging commands and status information. It is noted that the interfacing unit may be combined with the interface for data to input unit 27 and data from read unit 30. The host system accommodates applications that access the record carrier for storing and retrieving information. Accessing the record carrier is managed by a file management system, for example UDF. It is noted that the host system may be embodied by a separate processing unit, or may be performed as a logically separate function by the control unit itself.

The record carrier status means 32 are for detecting a record carrier update status in which information stored on the record carrier is to be changed. The update status may be based on the real-time performance of the device, e.g. the number of jumps to parts of a real-time file or to defective and remapped physical addresses. In an embodiment the update status is based on the amount of space available and used in the defect management areas. For example when a large amount of defect management area is unused while the record carrier is almost fill, the record carrier status means may decide to change the allocation of recording area, and increase the user storage space, while decreasing the defect management area.

In an embodiment the record carrier status means 32 are for detecting a series of blocks having a continuous logical address range to be updated for recording in a corresponding contiguous physical address range. The series of blocks can be detected by monitoring writing commands, and the logical addresses and physical addresses involved. Due to real-time constraints the drive may initially record the logically continuous logical addresses in different physical addresses. By applying the unmount-mount sequence and moving the blocks to contiguous physical address the device improves the real-time performance during retrieval at a later moment.

In an embodiment the record carrier status means 32 are for detecting a continuous recording indicator in a recording command, or for detecting the series of blocks representing real-time information, in particular video information. The type of recording is indicated by the host in the recording command, for example in a dedicated real-time bit. Further the type of information may be detected from the file constituted by the series of blocks, for example by recognizing a file name or a data structure of the file, which requires file system knowledge in the device.

The update unit 33 is for initiating an unmount-mount sequence in dependence on the record carrier update status. When the update status indicates that change of recorded information is required the unmount-mount sequence is started as explained in detail below with reference to FIG. 4. The unmount-mount sequence starts with an unmount command via the interfacing unit resulting in the host unmounting the record carrier. It is to be noted that the unmount command is initiated by the drive without a user activating an eject finction, and no actual physical eject occurs. Due to the unmount command the host is forced to complete pending actions and write any information maintained by the host to the record carrier. Usually some information is still in a cache memory, which is now forced to be recorded. Then an update process is performed for said changing of information on the record carrier. Finally the control is returned to the host by a mount command via the interfacing unit resulting in the host mounting the record carrier. Hence the host system is forced to accept the changed information by retrieving from the updated record carrier any information required by the host, such as file system or recording format information.

In an embodiment of the device a defect management unit 34 is included for detecting defects, for example by monitoring the signal quality of a read-out signal from the head 22 during recording and/or reading. The defects may also be detected by determining an error rate in retrieved information blocks. The defect management unit maintains the defect management information in defect management areas on the record carrier, for example in defect lists as defined for the DVD recordable systems like DVD+RW or the Mount Rainier defect management as defined for CD-MRW. A description of Mount Rainier and CD-MRW is available from Philips on http://www.licensing.philips.com/information/mtr/. The defect management information may include remapping information. Remapping is the process that a block having a logical address corresponding to the physical address that is defective is stored in an alternative physical address in a defect management area (DMA). The remapping information provides data for translating the logical address initially mapped to a physical address exhibiting a defect to an alternate physical address in a defect management area, for example an entry in a secondary defect list including the logical address of the remapped block and its corresponding physical address.

FIG. 3 shows a host system interfacing to a recording device. A host system 36 includes a processing unit 37, for example a PC, and a display 38. The recording device 39 is arranged as a drive unit to be connected to a separate host system, for example a drive unit to be build in a PC. The control unit 20 is arranged to communicate with a processing unit in the host system via the interface unit 31. Alternatively the recording drive is arranged as a stand alone unit, for example a video recording apparatus for consumer use. The control unit 20, or an additional host control unit included in the device, is arranged to be controlled directly by the user, and to also perform the functions of the file management system. The host system and the recording device are built in a single housing, for example a consumer digital disk video recorder.

FIG. 4 shows a process for detecting an update status and performing an unmount-mount sequence. The update process is started at step START 41 when the control unit 20 is available, i.e. not busy with high priority writing or reading tasks. In a step DETECT UPDATE STATUS 42 detects the need for changing information on the record carrier. If an update is required, an unmount-mount sequence starts with a step UNMOUNT 43. An unmount command is transferred via the interfacing means to the host system for forcing the host system to complete pending actions and write any information maintained by the host to the record carrier. In a step UPDATE 44 information on the record carrier is changed as deemed necessary by the recording device. After finishing said changing, in a step MOUNT 45 a mount command is transferred via the interfacing means to the host system for forcing the host system to accept the changed information by retrieving from the updated record carrier any information required by the host. The device returns to normal operation at step END 46. The unmount-mount sequence is required for the following reason.

When a File System (FS, usually running in a host) has mounted a medium, amongst others the file layout on that disc is known in the file system. Once a medium is mounted, a drive is normally not allowed to change anything with respect to the file layout at its own initiative, e.g. available free space on the medium, or generally any information about the disc that is known in the file system when a medium is mounted. Changing would lead to an inconsistency between the information about the medium in the FS and what is actually on the medium. A solution could be to just wait until the FS unmounts the medium. After that the drive could start with a number of different actions that influence some of the parameters that are known to the FS during the mounted period of the medium. An example could be to change the amount of defect management area on a medium at the expense of free data space. However waiting for an FS initiated unmount has a number of disadvantages. In general updating information on the record carrier results in a delay before a medium is unmounted. Typically after unmount the user wants to remove the medium from the drive. This either leaves the drive no time to perform the update actions or has the consequence that the user will have to wait until the drive is finished before it can remove the medium.

The solution is to include the drive initiated unmount-mount sequence. This can be done without any changes to the command set that is used for communication between the host and the drive (typically this will be ATAPI for optical media). Most if not all drives have a tray open button, which is used to send the host an event (usually two, first a EjectRequest followed by a MediaRemoval). These events are now intiated by the drive at its own initiative, instead of being a result of a user pressing the eject button. The FS will react with unmounting the file system if the ejectrequest is granted. The medium is than unmounted and the drive can perform all the actions it has planned.

Some examples of actions the drive could perform for updating the record carrier:
Change the size of the Defect Management Area (DMA) by exchanging DMA with free space in the user storage area. Also other areas on the record carrier which are under control of the recording device, such as recording power test areas, can be changed in size by exchanging physical address space with the user storage area.
Move data on the medium to create contiguous files that will have a better real-time performance. For example parts of a file having a lot of remapped errors could be moved to a new location having fewer errors. Alternatively blocks of such files can be moved for skipping defects instead of remapping each individual defect An end portion of such a file can be recorded in a free location on the record carrier. File system data has to be updated to reflect the new locations of the parts of the file. In an embodiment a free location on the record carrier is detected, and previously recorded blocks are retrieved from a physical address range. The retrieved previously recorded blocks are recorded in the free location. Finally the file system information is updated for indicating the new logical addresses of said retrieved previously recorded blocks as part of a file.
Change any of the parameters that the FS normally retrieves during the mounting and get the host to reread that information by getting it to mount the medium again, for example a record carrier type or version of the recording format used on the record carrier. If the record carrier has been formatted or data has been recorded using a different recording device that has an old version of the recording format, the recording device has the option of updating the recording format used on the record carrier to a newer version available in the current recording device. Hence system areas and/or parameters of the user data and/or file system data have to be updated also.

After the update process has been completed, the recording device sends an event to the host indicating that a new medium is inserted (a NewMedia event). As a result of that, the FS will mount the medium and will retrieve the updated/changed parameters from the medium. After this the host can just continue to use the medium.

In an embodiment the interface unit 31 is provided with additional commands (possibly vendor specific). A new interface command is defined that takes care of the drive initiated unmount-mount, instead of using the events as indicated above. In an embodiment a specific conditional unmount command gives the host an estimation of the total amount of time for the unmount-mount sequence, or of the urgency of the request. Based on the request specifying the conditions the host has the ability to grant or deny the sequence at that point in time.

Although the invention has been explained mainly by embodiments using optical discs like the CD, DVD or BD, other media such as a magnetic hard disc can be used. Even if the record carrier cannot be physically removed the virtual unmount-mount sequence can be applied to take over control temporarily. It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ may be represented by the same item of hardware. Further, the scope of the invention is not limited to the embodiments, and the invention lies in each and every novel feature or combination of features described above.

1. Device for recording information in blocks having logical addresses in a storage space on a record carrier, which device comprises
recording means (22) for recording marks in a track on the record carrier representing the information, and
control means (20) for controlling the recording by locating each block at a physical address in the track, the control means comprising
interfacing means (31) for communicating with a host system by exchanging commands and information,
record carrier status means (32) for detecting a record carrier update status in which information stored on the record carrier is to be changed, and
update means (33) for initiating an unmount-mount sequence in dependence on the record carrier update status, the unmount-mount sequence comprising an unmount process for, via the interfacing means, forcing the host system to complete pending actions and write any information maintained by the host to the record carrier, an update process for said changing of information on the record carrier, and a mount process for, via the interfacing means, forcing the host system to accept the changed information by retrieving from the updated record carrier any information required by the host.

2. Device as claimed in claim 1, wherein the update means (33) are adapted for including in the update process changing the size of the storage space.

3. Device as claimed in claim 1, wherein the control means (20) comprise defect management means (34) for detecting defects and maintaining the defect management information in defect management areas on the record carrier, and wherein the update means (33) are adapted for including in the update process changing the content, size and/or location of the defect management areas.

4. Device as claimed in claim 3, wherein the defect management information at least includes remapping information indicative for translating a logical address initially mapped to a physical address exhibiting a defect to an alternate physical address in a defect management area, and wherein the update means (33) are adapted for including in the update process changing the remapping information.

5. Device as claimed in claim 1, wherein the record carrier status means (32) are for detecting a series of blocks having a continuous logical address range to be updated for recording in a corresponding contiguous physical address range.

6. Device as claimed in claim 5, wherein the record carrier status means (32) are for detecting a continuous recording indicator in a recording command, or for detecting the series of blocks representing real-time information, in particular video information.

7. Device as claimed in claim 1, wherein the update means (33) are adapted for including in the update process rewriting blocks that are part of a logically continuous series of blocks on substantially adjacent physical addresses.

8. Device as claimed in claim 7, wherein the update means (33) are adapted for including in the update process adapting file management information.

9. Device as claimed in claim 8, wherein the update means (33) are for detecting a free location on the record carrier, for retrieving previously recorded blocks in a physical address range, for recording said retrieved previously recorded blocks in the free location, and for updating file system information indicating the logical addresses of said retrieved previously recorded blocks as part of a file.

10. Device as claimed in claim 1, wherein the update means (33) are adapted for including in the update process adapting record carrier format information, in particular the disc type or the version of the format of the recorded information.

11. Device as claimed in claim 1, wherein the interfacing means (31) are adapted to include a command for a indicating a period of time required for the update process, in particular a conditional unmount request.

12. Method of recording information, which method comprises recording information in blocks having logical addresses in a storage space on a record carrier,
controlling the recording by locating each block at a physical address in a track on the record carrier,
interfacing with a host system by exchanging commands and information,
detecting a record carrier update status in which information stored on the record carrier is to be changed,
initiating an unmount-mount sequence in dependence on the record carrier update status, the unmount-mount sequence comprising an unmount step for, via said interfacing, forcing the host system to complete pending actions and write any information maintained by the host to the record carrier, an update step for said changing of information on the record carrier, and a mount step for, via said interfacing, forcing the host system to accept the changed information by retrieving from the updated record carrier any information required by the host.

13. Computer program product for recording information, which program is operative to cause a processor to perform the method as claimed in claim 12.
